(19) United States
(12) Patent Application Publication
(10) Pub. No.: US 2021/0324824 A1
(43) Pub. Date: Oct. 21, 2021

(54) FUEL INJECTOR AND METHOD FOR OPERATING A FUEL INJECTOR

(71) Applicant: Robert Bosch GmbH, Stuttgart (DE)

(72) Inventors: Johannes Unrath, Heimerdingen (DE); Henning Kreschel, Ludwigsburg (DE); Thomas Schwarz, Schorndorf (DE); Boerries Belkner, Stuttgart (DE); Christian Grimminger, Leonberg (DE); Violaine Chassagnoux, Stuttgart (DE)

(21) Appl. No.: 17/259,611

(22) PCT Filed: Jul. 3, 2019
(86) PCT No.: PCT/EP2019/067793

§ 371 Date: Jan. 12, 2021

(30) Foreign Application Priority Data
Jul. 12, 2018 (DE) 10 2018 211 679.2

(51) Int. Cl. F02M 63/00; F02M 61/10

(52) U.S. Cl. CPC F02M 63/0015; F02M 61/10; F02M 63/0028

(57) ABSTRACT

The invention relates to a method for operating a fuel injector (10) and to a fuel injector (10) which is configured to carry out the method. The method comprises the steps of introducing a fuel under high pressure into a feed passage (78) and branching off a substream of the fuel under high pressure into a control space (74) in which an axial end face (70) of the nozzle needle (50) is loaded with the pressure such that the nozzle needle (50) is hydraulically loaded in the closing direction, and of opening a control valve (90) such that an outflow path arranged downstream of the control valve (90) in an outflow direction is freed and fuel flows out of the control space (74) in order to relieve the nozzle needle (50), wherein the fuel flowing out via the outflow path is divided into at least two substreams.

### BACKGROUND OF THE INVENTION

The invention relates to a method for operating a fuel injector, and to a fuel injector which is configured for carrying out the method. The invention relates in particular to embodiments of a fuel injector for reducing low-pressure oscillations.

Fuel injectors are used in particular in common-rail injection systems for the injection of fuel into a combustion chamber of a diesel engine.

DE 10 2010 028 011 A1 has disclosed a fuel injector which exhibits improved high-pressure resistance of the valve chamber.

The background to the invention lies in the fact that, to adhere to reduced emissions limits in diesel engines with the new generations of injectors, use is made of injection scenarios with multiple injections per cycle and short injection intervals. These result in pressure oscillations, which are superposed on one another in a variety of ways, both in the high-pressure region and in the low-pressure region of the injectors. As a result of the actuation shocks in the case of repeated actuation of a piezo injector, that is to say upon the opening of the switching valve, pressure undershoot events occur in the low-pressure region in the case of adverse superposition of the low-pressure oscillations, which pressure undershoot events lead, as a result of vapor formation and the subsequent vapor bubble collapse, to cavitation at various points of the injector in the low-pressure region.

### SUMMARY OF THE INVENTION

It is therefore the object of the present invention to provide a method for operating a fuel injector and to provide a fuel injector, with which, in the critical injection scenarios, negative pressures are avoided or reduced to such an extent that no cavitation occurs.

The object is achieved by a method for operating a fuel injector and a fuel injector according to the invention.

The method according to the invention comprises the step of introducing a highly pressurized fuel into an inlet channel and branching off a partial stream of the highly pressurized fuel into a control chamber in which an axial end side of the nozzle needle is subjected to load by the pressure, such that the nozzle needle is hydraulically loaded in a closing direction, the further step of opening a control valve such that an outflow path arranged downstream of the control valve in an outflow direction is opened up and fuel flows out of the control chamber, in order to relieve the nozzle needle of load, wherein the fuel flowing out via the outflow path is split up into at least two partial streams.

As a result of the splitting-up of the fuel flowing out via the outflow path, the volume of the outflow path is increased, such that an amplitude of the discharge shock arising from the opening and closing movement is reduced. This leads to a lower shock energy, whereby the potential for undershoot events is reduced, and cavitation can be avoided. Additionally, in the event of a merging of the partial streams, a partial attenuation of the low-pressure oscillations can occur, such that a risk of cavitation is additionally reduced.

In a preferred embodiment of the invention, at least one partial stream of the fuel in the outflow path is conducted into an annular chamber at a radial outer side of the valve plate. Here, an annular chamber is to be understood to mean a chamber which is in the shape of a hollow cylinder and which is delimited by the valve plate and by a clamping nut surrounding the valve plate. In this way, an additional volume chamber is formed into which a partial stream of the fuel can flow out during the injection processes. The shock energy during the injections is reduced by means of such an annular chamber, such that cavitation is reduced.

In a further preferred embodiment of the invention, at least one partial stream of the fuel in the outflow path flows out over a structurally lengthened distance. Here, a structurally lengthened distance is to be understood to mean that one partial stream, before being merged with the further partial stream, is diverted and in the process covers a greater distance, such that a superposition of the low-pressure oscillations of the partial streams occurs, and the oscillations in the low-pressure region partially attenuate one another. As a result, the low-pressure oscillations and consequently the cavitation are reduced. Furthermore, the volume of the outflow path as a whole is increased, such that a shock energy is reduced.

The invention additionally comprises a fuel injector which is configured to carry out the method according to the invention. Here, the fuel injector comprises a control chamber into which a fuel can be introduced at high pressure such that a force can be exerted on an axial end side, which delimits the control chamber, of a nozzle needle, such that the nozzle needle is hydraulically loaded in a closing direction, an outlet bore which is formed in a throttle plate and which is connected to the control chamber and which has an outlet throttle, a control valve which is arranged in a valve plate, said control valve having a valve chamber, which is connected to the outlet bore, and having a valve body, which interacts with a valve seat surface such that, when the control valve is open, fuel can be discharged from the valve chamber, a low-pressure chamber which is delimited by the valve plate and a coupler body and which is fluidically connected to the valve chamber, wherein the coupler body has at least one opening for connection to a return line, which forms a part of an outflow path, a groove which is formed between valve plate and throttle plate and which is connected via at least one rising line to the return line, such that fuel can be led out of the rising line via the return line, and at least one outflow line, which is arranged between the low-pressure chamber and the groove and/or the rising line and which fluidically connects the low-pressure chamber to the groove and/or to the rising line, such that the fuel flowing out via the outflow path can be split up.

The method according to the invention can be carried out by means of the fuel injector, such that the advantages mentioned with regard to said method can be attained.

In a preferred embodiment of the invention, at least one outflow line is formed such that the low-pressure chamber is connected to an annular chamber at a radial outer side of the valve plate. The advantages mentioned with regard to the method are achieved by means of such an annular chamber.

In a further preferred embodiment of the invention, the at least one outflow line is formed as a bore. A bore has the advantage that it can be produced easily and economically and exhibits only low flow losses.

A surface cutout is preferably arranged between coupler body and return line. Here, a surface cutout is to be understood to mean a material-free region which may be produced for example by means of milling. A fluidic connection between coupler body and return line is improved by means of such a surface cutout. Additionally, by means of such a region, an additional volume chamber is created, such that the shock energy is reduced and the risk of cavitation is reduced.

In one advantageous embodiment, in the throttle plate, there is formed an inlet bore with an inlet throttle which is connected to the control chamber, such that a fuel can be introduced at high pressure into the control chamber. In this way, fast filling of the control chamber and thus a rapid closure of the nozzle needle are attained.

In the throttle plate, there is preferably formed a filling bore which connects a high-pressure chamber, which is formed in the nozzle body and which surrounds the nozzle needle, to the valve chamber. By means of the filling bore, a bypass is formed which, after a closure of the control valve, leads to a more rapid pressure build-up in the valve chamber, such that the nozzle needle is more quickly hydraulically loaded in a closing direction. In this way, short injection intervals are made possible.

In a particularly advantageous embodiment, the fuel injector is a piezo injector. Here, a piezo injector has the advantage that it has a fast response time.

### BRIEF DESCRIPTION OF THE DRAWINGS

Exemplary embodiments of the invention are illustrated in the drawing and explained in more detail in the following description. In the drawing:

FIG. 1 shows a fuel injector according to a first exemplary embodiment of the invention,

FIG. 2 shows an illustration of the throttle plate and of the valve plate as per FIG. 1, and

FIG. 3 shows a view of a valve plate according to a second exemplary embodiment of the invention.

### DETAILED DESCRIPTION

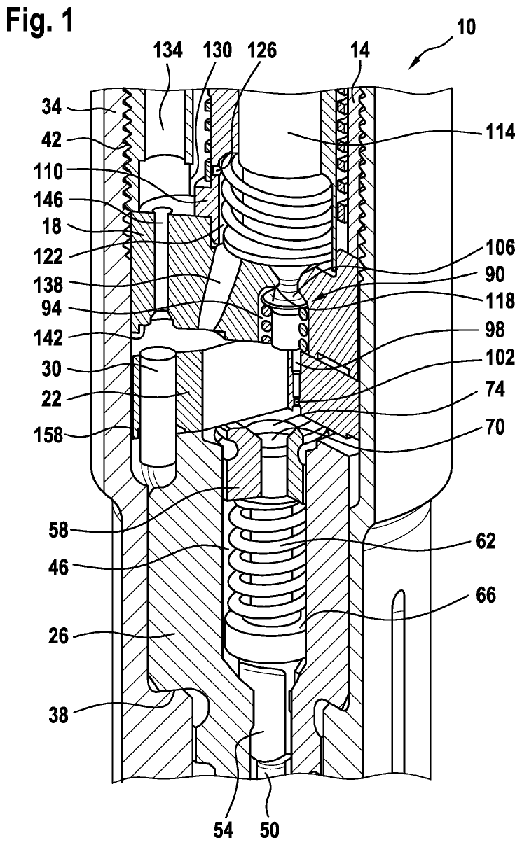

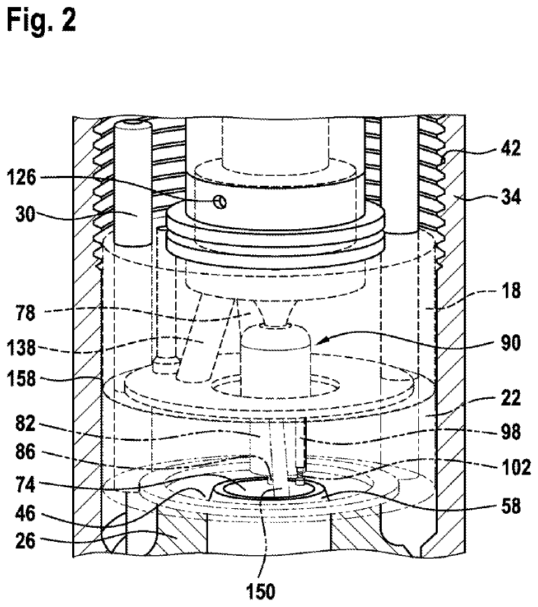

FIG. 1 shows a fuel injector 10 according to a first exemplary embodiment of the invention. The fuel injector 10 has a holding body 14, a valve plate 18, a throttle plate 22 and a nozzle body 26, which lie against one another in this sequence and are connected to one another, so as to be fixed against relative rotation, by means of bolts 30 (see also FIG. 2). The components are pressed against one another by means of a clamping nut 34 which is supported on a shoulder 38 of the nozzle body 26 and which is held by means of a thread 42 on the holding body 14. In the nozzle body 26, there is formed a high-pressure chamber 46 in which a piston-shaped nozzle needle 50 is arranged in longitudinally displaceable fashion. The nozzle needle 50 is guided, in a central section, in the high-pressure chamber 46, wherein the fuel is conducted past multiple ground portions 54 to an injection region which is not shown.

At an axial end of the nozzle needle 50 which is situated opposite the injection region, said nozzle needle is surrounded by a sleeve 58, wherein the sleeve 58 is pressed against the throttle plate 22 by means of a closing spring 62 which surrounds the nozzle needle 50 and which, at a side of the closing spring 62 which is situated opposite the sleeve 58, is supported on a shoulder 66. The sleeve 58, the throttle plate 22 and an axial end side 70, averted from the injection region, of the nozzle needle 50 delimit a control chamber 74 which is filled with fuel, such that, by means of the pressure in the control chamber 74, a hydraulic force is exerted on the axial end side 70 of the nozzle needle 50, and the nozzle needle 50 is hydraulically loaded in a closing direction.

In the holding body 14, the valve plate 18 and the throttle plate 22, there is formed an inlet channel 78 (see FIG. 2) via which compressed fuel is conducted at high pressure from a high-pressure fuel source (not shown) into the high-pressure chamber 46. The inlet channel 78 is connected to the control chamber 74 via an inlet bore 82 which is formed in the throttle plate 22 and which has an inlet throttle (see FIG. 2) 86. In this way, the same pressure as in the high-pressure chamber 46 appears in the control chamber 74.

To control the pressure in the control chamber 74, a control valve 90 is arranged in the valve plate 18, which control valve comprises a valve chamber 94 which is connected via an outlet bore 98, which is formed in the throttle plate 22 and which has an outlet throttle 102 (see FIG. 1 or 2), to the control chamber 74. The control valve 90 comprises a valve body 106 which is movable in the valve chamber 94 between a closed position and an open position by means of a piston 114, which is movable by means of an electrical actuator (not shown) and which is guided in a coupler body 110. In a closed position of the control valve 90, the valve body 106 interacts sealingly with a valve seat surface 118, such that an outflow of the fuel from the valve chamber 94 is prevented. In an open position of the valve body 106, the fuel flows out of the valve chamber 94, such that the pressure in the control chamber 74 is reduced and the nozzle needle 50 is displaced in the direction of the valve chamber 94, whereby fuel can be injected into a combustion chamber. In the open position of the valve body 106, the fuel is led out into a low-pressure chamber 122 which is delimited by the valve plate 18 and by the coupler body 110. In the coupler body 110, there are arranged multiple openings 126 which connect the low-pressure chamber 122 via a surface cutout 130 to a return line 134 formed in the holding body 14.

In the valve plate 18, there is formed an outflow line 138 which connects the low-pressure chamber 122 to a groove 142 which is arranged between the valve plate 18 and the throttle plate 22 and which is formed as an encircling annular groove. In this way, a proportion of the fuel can be led out of the low-pressure chamber 122 via the outflow line 138 into the annular groove 142. Additionally formed in the valve plate 18 is a rising line 146 which connects the annular groove 142 to the return line 134. A proportion of the returned fuel thus flows out over a lengthened distance.

Additionally shown in FIG. 2 is a filling bore 150 which extends in the throttle plate 22 between the high-pressure chamber 46 and the valve chamber 94, such that a replenishment of fuel into the valve chamber 94 is made possible. After the closing of the valve body 106, a pressure build-up occurs in the valve chamber 94 owing to the replenishing flow of fuel. This pressure build-up can be accelerated by means of the filling bore 150, such that the pressure in the control chamber 74 also builds up more quickly, and the nozzle needle 50 is more quickly hydraulically loaded in a closing direction.

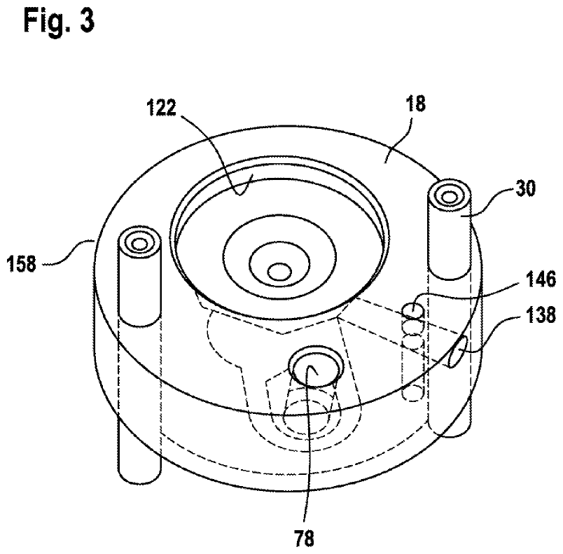

FIG. 3 shows a view of a valve plate 18 according to a second exemplary embodiment of the invention. This exemplary embodiment differs from the first exemplary embodiment in particular in that the outflow line 138 is arranged directly between the low-pressure chamber 122 and the rising line 146. In this way, the fuel is introduced directly into the rising line 146. Furthermore, the outflow line 138 is connected to an annular space 158 (see also FIGS. 1 and 2) formed between the clamping nut 34 and a radial outer side of the valve plate 18.

1. A method for operating a fuel injector (10), wherein the method comprises the steps:
introducing a highly pressurized fuel into an inlet channel (78) and branching off a partial stream of the highly pressurized fuel into a control chamber (74) in which an axial end side (70) of a nozzle needle (50) is subjected to load by the pressure, such that the nozzle needle (50) is hydraulically loaded in a closing direction, and
opening a control valve (90) such that an outflow path arranged downstream of the control valve (90) in an outflow direction is opened up and fuel flows out of the control chamber (74), in order to relieve the nozzle needle (50) of load,
wherein the fuel flowing out via the outflow path is split up into at least two partial streams.

2. The method for operating a fuel injector (10) as claimed in claim 1, characterized in that at least one partial stream of the fuel in the outflow path is conducted into an annular chamber (158) at a radial outer side of a valve plate (18).

3. The method for operating a fuel injector (10) as claimed in claim 1, characterized in that at least one partial stream of the fuel in the outflow path flows out over a structurally lengthened distance.

4. A fuel injector (10) which is configured for carrying out a method as claimed claim 1, comprising:
a control chamber (74) into which a fuel can be introduced at high pressure such that a force can be exerted on an axial end side (70), which delimits the control chamber (74), of a nozzle needle (50), such that the nozzle needle (50) is hydraulically loaded in a closing direction,
an outlet bore (98) which is formed in a throttle plate (22) and which is connected to the control chamber (74) and which has an outlet throttle (102),
a control valve (90) which is arranged in a valve plate (18), said control valve having a valve chamber (94), which is connected to the outlet bore (98), and having a valve body (106), which interacts with a valve seat surface (118) such that, when the control valve (90) is open, fuel can be discharged from the valve chamber (94),
a low-pressure chamber (122) which is delimited by the valve plate (18) and a coupler body (110) and which is fluidically connected to the valve chamber (94), wherein the coupler body (110) has at least one opening (126) for connection to a return line (134), which forms a part of an outflow path,
a groove (142) which is formed between the valve plate (18) and the throttle plate (22) and which is connected via at least one rising line (146) to the return line (134), such that fuel can be led out of the rising line (146) via the return line (134), and
at least one outflow line (138), which is arranged between the low-pressure chamber (122) and the groove (142) and/or the rising line (146) and which fluidically connects the low-pressure chamber (122) to the groove (142) and/or to the rising line (146), such that the fuel flowing out via the outflow path can be split up.

5. The fuel injector (10) as claimed in claim 4, characterized in that at least one outflow line (138) is formed such that the low-pressure chamber (122) is connected to an annular chamber (158) at a radial outer side of the valve plate (18).

6. The fuel injector (10) as claimed in claim 4, characterized in that the at least one outflow line (138) is formed as a bore.

7. The fuel injector (10) as claimed in claim 4, characterized in that a surface cutout (130) is arranged between the coupler body (110) and the return line (134).

8. The fuel injector (10) as claimed in claim 4, characterized in that, in the throttle plate (22), there is formed an inlet bore (82) with an inlet throttle (86) which is connected to the control chamber (74), such that a fuel can be introduced at high pressure into the control chamber (74).

9. The fuel injector (10) as claimed in claim 4, characterized in that, in the throttle plate (22), there is formed a filling bore (150) which connects a high-pressure chamber (46), which is formed in the nozzle body (26) and which surrounds the nozzle needle (50), to the valve chamber (94).

10. The fuel injector (10) as claimed in claim 4, characterized in that the fuel injector (10) is a piezo injector.
